(19) United States
(12) Patent Application Publication
(10) Pub. No.: US 2010/0015532 A1
(43) Pub. Date: Jan. 21, 2010

(54) NEGATIVE ELECTRODE AND NON-AQUEOUS ELECTROLYTE SECONDARY BATTERY USING THE SAME

(76) Inventors: Takao Inoue, Aichi (JP); Kumiko Kanai, Osaka (JP); Masaharu Itaya, Kyoto (JP); Masahisa Fujimoto, Osaka (JP)

Correspondence Address: KRATZ, QUINTOS & HANSON, LLP, 1420 K Street, N.W., Suite 400, WASHINGTON, DC, 20005, US

(21) Appl. No.: 11/883,847

(22) PCT Filed: Jan. 20, 2006
(86) PCT No.: PCT/JP2006/300883

§ 371 Date: Oct. 8, 2009

(30) Foreign Application Priority Data
Feb. 7, 2005 (JP) 2005-030891
Jun. 7, 2005 (JP) 2005-167001

(51) Int. Cl. H01M 6/16; H01M 4/38; H01M 6/14

(52) U.S. Cl. 429/338; 429/218.1; 429/199; 429/342; 429/339; 429/341

(57) ABSTRACT

A rolled foil of surface roughened copper as thick as 26 μm for example having a surface formed into an irregular shape with copper precipitated thereon by an electrolytic method is prepared as a negative electrode collector. Tin (Sn) or germanium (Ge) is deposited on the rolled foil described above, so that a negative electrode active material layer is formed. Note that the deposited tin or germanium is amorphous. The arithmetic mean roughness Ra in the surface-roughened rolled foil described above is preferably not less than 0.1 μm nor more than 10 μm. A non-aqueous electrolyte is produced by adding sodium hexafluorophosphate as an electrolyte salt in a concentration of 1 mol/l to a non-aqueous solvent produced by mixing ethylene carbonate and diethyl carbonate in the ratio of 50:50 by volume.

### TECHNICAL FIELD

The present invention relates to a negative electrode, and a non-aqueous electrolyte secondary battery including the negative electrode, a positive electrode, and a non-aqueous electrolyte.

### BACKGROUND ART

Today, non-aqueous electrolyte secondary batteries are in wide use as secondary batteries with high energy density, in which lithium ions for example are transferred between a positive electrode and a negative electrode to carry out charge and discharge.

In such a non-aqueous electrolyte secondary battery in general, a composite oxide of a lithium transition metal having a layered structure of lithium nickel oxide (LiNiO₂), lithium cobalt oxide (LiCoO₂) or the like is used as the positive electrode, and a carbon material capable of storing and releasing lithium, a lithium metal, a lithium alloy, or the like is used as the negative electrode (see, for example, Patent Document 1).

The non-aqueous electrolyte produced by dissolving an electrolyte salt such as lithium tetrafluoroborate (LiBF₄) or lithium hexafluorophosphate (LiPF₆) in an organic solvent such as ethylene carbonate or diethyl carbonate is used.

Meanwhile, researches concerning non-aqueous electrolyte secondary batteries using sodium ions instead of lithium ions have recently been started. The negative electrode of the non-aqueous electrolyte secondary battery includes a metal containing sodium. There are abundant supplies of sodium from seawater, and therefore the use of sodium can reduce the cost.

[Patent Document 1] JP 2003-151549 A

### DISCLOSURE OF THE INVENTION

### Problems to be Solved by the Invention

The charge and discharge reaction of a non-aqueous electrolyte secondary battery using sodium is carried out by dissolution and precipitation of sodium ions and therefore a good charge/discharge efficiency and a good charge/discharge characteristic are not obtained.

Repetition of charge and discharge process causes a branch-like precipitate (dendrite) to be more easily generated in the non-aqueous electrolyte. The dendrite may cause internal short-circuiting, and sufficient safety cannot be secured.

In such a non-aqueous electrolyte secondary battery using sodium ions, if a negative electrode containing highly practical carbon capable of storing and releasing lithium ions is used, sodium ions are not sufficiently stored in and released from the negative electrode and high specific charge/discharge capacity cannot be obtained. Similarly, if a negative electrode containing silicon is used, sodium ions are not stored in and released from the negative electrode.

It is an object of the invention to provide a negative electrode capable of storing and releasing ions.

Another object of the invention is to provide an inexpensive non-aqueous electrolyte secondary battery that allows reversible charge and discharge to be carried out.

### Means for Solving the Problems

A negative electrode according to one aspect of the invention includes elemental tin or elemental germanium.

In the negative electrode according to the invention, the use of the negative electrode containing elemental tin or elemental germanium, ions of the non-aqueous electrolyte are sufficiently stored in and released from the negative electrode.

The negative electrode may further include a collector including a metal, and the elemental tin and elemental germanium may be formed into a thin film state on the collector.

In this way, the elemental tin and the elemental germanium are readily formed on the collector as a thin film.

The collector may have a roughened surface. When the elemental tin or elemental germanium is deposited on the collector of the negative electrode having its surface roughened, the surface of the layer including the deposited elemental tin or elemental germanium (hereinafter referred to as “negative electrode active material layer”) has a shape conforming to the irregular shape on the collector caused by the roughening.

When charge and discharge process is carried out using the negative electrode active material layer, stress associated with expansion and contraction of the negative electrode active material layer concentrates at the irregular part of the negative electrode active material layer, so that cracks are formed in the irregular part of the negative electrode active material layer. The cracks allow the stress generated by the charge and discharge to be dispersed. In this way, reversible charge and discharge can be carried out more easily, and a good charge/discharge characteristic can be obtained.

The arithmetic mean roughness of the surface of the collector may be not less than 0.1 μm nor more than 10 μm. In this way, reversible charge and discharge is more easily carried out, and a better charge/discharge characteristic can be obtained.

A non-aqueous electrolyte secondary battery according to another aspect of the invention includes a negative electrode, a positive electrode, and a non-aqueous electrolyte containing sodium ions, and the negative electrode includes elemental tin or elemental germanium.

In the non-aqueous electrolyte secondary battery according to the invention, using the negative electrode including the elemental tin or elemental germanium, sodium ions are sufficiently stored in and released from the negative electrode. In this way, reversible charge and discharge can be carried out.

In addition, the use of sodium that is available in abundance as a resource and inexpensive elemental tin can reduce the cost.

The non-aqueous electrolyte may include sodium hexafluorophosphate. In this way, improved safety can be secured.

The non-aqueous electrolyte may include one or more selected from the group consisting of a cyclic carbonate, a chain carbonate, esters, cyclic ethers, chain ethers, nitrites, and amides. In this way, the cost can be reduced and improved safety can be secured.

### EFFECTS OF THE INVENTION

According to the invention, the use of the negative electrode containing elemental tin or elemental germanium allows sodium ions to be sufficiently stored in and released from the negative electrode. The use of sodium that is available in abundance as a resource and inexpensive elemental tin can reduce the cost.

In addition, the use of the negative electrode described above allows reversible charge and discharge to be carried out and an inexpensive non-aqueous electrolyte secondary battery to be provided.

### BRIEF DESCRIPTION OF THE DRAWINGS

FIG. 1 is a schematic view of a test cell of a non-aqueous electrolyte secondary battery according to an embodiment.

FIG. 2 is a binary phase diagram of sodium and tin.

FIG. 3 is a schematic view of a sputtering apparatus.

FIG. 4 is a binary phase diagram of germanium and sodium.

FIG. 5 is a graph showing the charge/discharge characteristic of a non-aqueous electrolyte secondary battery according to Inventive Example 1.

FIG. 6(a) is a photograph of a working electrode before the electrode stored sodium ions, and FIG. 6(b) is a photograph of the working electrode after the electrode stored sodium ions.

FIG. 7 is a graph showing the charge/discharge characteristic of a non-aqueous electrolyte secondary battery according to Inventive Example 2.

FIG. 8(a) is a photograph of a working electrode before the electrode stored sodium ions, and FIG. 8(b) is a photograph of the working electrode after the electrode stored sodium ions.

FIG. 9 is a graph showing the charge/discharge characteristic of a non-aqueous electrolyte secondary battery according to Inventive Example 3.

### BEST MODE FOR CARRYING OUT THE INVENTION

In the following paragraphs, negative electrodes according to embodiments and non-aqueous electrolyte secondary batteries using the negative electrodes will be described.

### First Embodiment

The non-aqueous electrolyte secondary battery according to the embodiment includes a positive electrode, a negative electrode, and a non-aqueous electrolyte.

Note that the materials, and the thickness, the concentrations and the like of the materials are not limited to those in the following description and may be set as required.

<Manufacture of Working Electrode>

A rolled foil of surface roughened copper as thickness as 26 μm for example having a surface formed into an irregular shape with copper precipitated thereon by an electrolytic method is prepared as a negative electrode collector.

Elemental tin (Sn) having a thickness of 2 μm for example is deposited on the rolled foil described above and a negative electrode active material layer is formed. Note that the deposited elemental tin is amorphous.

Then, the rolled foil having the negative electrode active material layer formed thereon is cut into a 2-by-2 cm piece and a negative electrode tab is attached to the rolled foil, so that the working (negative) electrode is produced.

The arithmetic mean roughness Ra as a parameter representing a surface roughness defined by Japanese Industrial Standards (JIS B 0601-1994) in the surface-roughened rolled foil described above is preferably not less than 0.1 μm nor more than 10 μm. The arithmetic mean roughness Ra can be measured using for example a stylus type surface roughness meter.

When the amorphous negative electrode active material layer is deposited on the negative electrode collector having its surface formed into the irregular shape, the surface of the negative electrode active material layer has a shape conforming to the irregular shape on the negative electrode collector.

When charge and discharge process is carried out using the negative electrode active material layer, stress associated with expansion and contraction of the negative electrode active material layer concentrates at the irregular part of the negative electrode active material layer, so that cracks are formed in the irregular part of the negative electrode active material layer. The cracks allow the stress generated by the charge and discharge to be dispersed. In this way, reversible charge and discharge can be carried out more easily, and a good charge/discharge characteristic can be obtained.

<Manufacture of Non-Aqueous Electrolyte>

A non-aqueous electrolyte produced by dissolving an electrolyte salt in a non-aqueous solvent may be used.

Examples of the non-aqueous solvent may include a cyclic carbonate, a chain carbonate, esters, cyclic ethers, chain ethers, nitrites, amides, and a combination thereof, which are typically used as a non-aqueous solvent for a battery.

Examples of the cyclic carbonate may include ethylene carbonate, propylene carbonate, butylene carbonate, and any of the above having its hydrogen group partly or entirely fluorinated such as trifluoropropylene carbonate and fluoroethyl carbonate.

Examples of the chain carbonate may include dimethyl carbonate, ethyl methyl carbonate, diethyl carbonate, methyl propyl carbonate, ethyl propyl carbonate, methyl isopropyl carbonate, and any of the above having its hydrogen group partly or entirely fluorinated.

Examples of the esters may include methyl acetate, ethyl acetate, propyl acetate, methyl propionate, ethyl propionate, and γ-butyrolactone. Examples of the cyclic ethers may include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and a crown ether.

Examples of the chain ethers may include 1,2-dimethoxyethane, diethyl ether, dipropyl ether, diisopropyl ether, dibutyl ether, dihexyl ether, ethyl vinyl ether, butyl vinyl ether, methylphenyl ether, ethylphenyl ether, butylphenyl ether, pentylphenyl ether, methoxytoluene, benzylethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, trienthylene glycol dimethyl ether, and tetraethylene glycol dimethyl.

An example of the nitriles may include acetonitrile, and an example of the amides may include dimethylformamide.

Examples of the electrolyte salt may include substances excluding peroxides with high safety that are soluble to a non-aqueous solvent such as sodium hexafluorophosphate (NaPF₆), sodium tetrafluoroborate (NaBF₄), NaCF₃SO₃, and NaBeTi. Note that one of the above electrolyte salts may be used or two or more of the above may be combined for use.

According to the embodiment, the non-aqueous electrolyte is produced by adding sodium hexafluorophosphate as the electrolyte salt in a concentration of 1 mol/l to a non-aqueous solvent produced by mixing ethylene carbonate and diethyl carbonate in the ratio of 50:50 by volume.

<Manufacture of Non-Aqueous Electrolyte Secondary Battery>

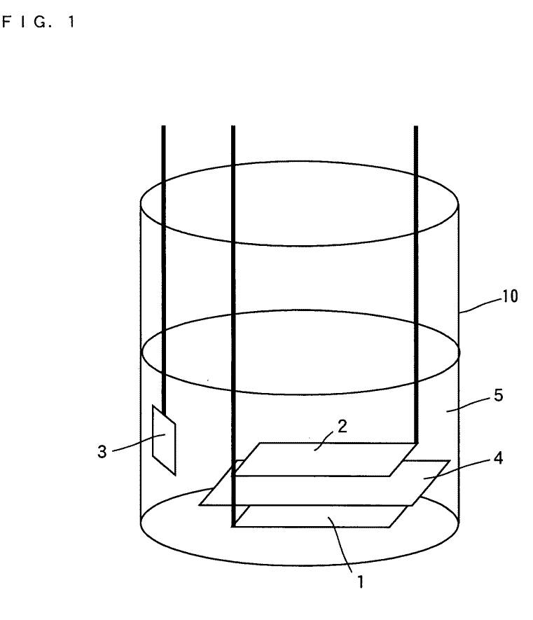

FIG. 1 is a schematic view for use in illustrating a non-aqueous electrolyte secondary battery according to the embodiment.

As shown in FIG. 1, in an inert atmosphere, a lead is attached to the working electrode 1 described above and a lead is attached to a counter electrode 2 for example of a sodium metal. Note that in place of the counter electrode 2 of the sodium metal, the counter electrode 2 of another material such as a carbon material and conductive polymer capable of storing and releasing sodium ions may be used.

Then, a separator 4 is inserted between the working electrode 1 and the counter electrode 2, and the working electrode 1, the counter electrode 2, and a reference electrode 3 for example of a sodium metal are provided in a cell container 10. The non-aqueous electrolyte 5 is then injected into the cell container 10 to produce the test cell.

<Effects of Embodiment>

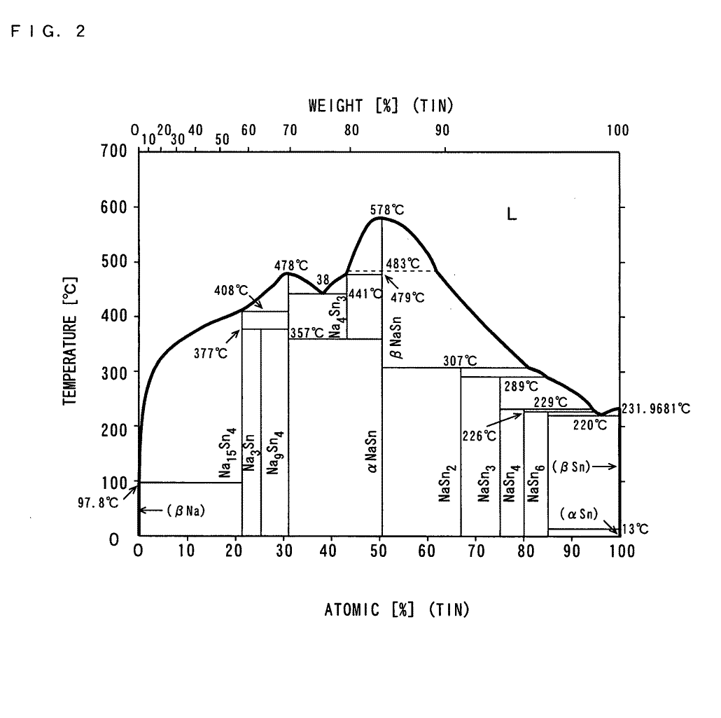

As can be understood from the binary phase diagram of sodium and elemental tin in FIG. 2, sodium and elemental tin are alloyed. However, there had not been findings about whether the elemental tin was capable of storing and releasing sodium ions before the present application.

According to the embodiment, the use of the negative electrode containing elemental tin allows sodium ions to be sufficiently stored in and released from the negative electrode. The use of sodium that is available in abundance as a resource and inexpensive tin can reduce the cost.

According to the embodiment, the use of the negative electrode described above allows reversible charge and discharge to be carried out and an inexpensive non-aqueous electrolyte secondary battery to be provided.

### Second Embodiment

A non-aqueous electrolyte secondary battery according to a second embodiment is different from the non-aqueous electrolyte secondary battery according to the first embodiment in the structure of the negative electrode, which will be described in detail.

<Manufacture of Working Electrode>

A rolled foil of surface roughened copper as thick as 26 μm for example having a surface formed into an irregular shape with copper precipitated thereon by an electrolytic method is prepared as a negative electrode collector.

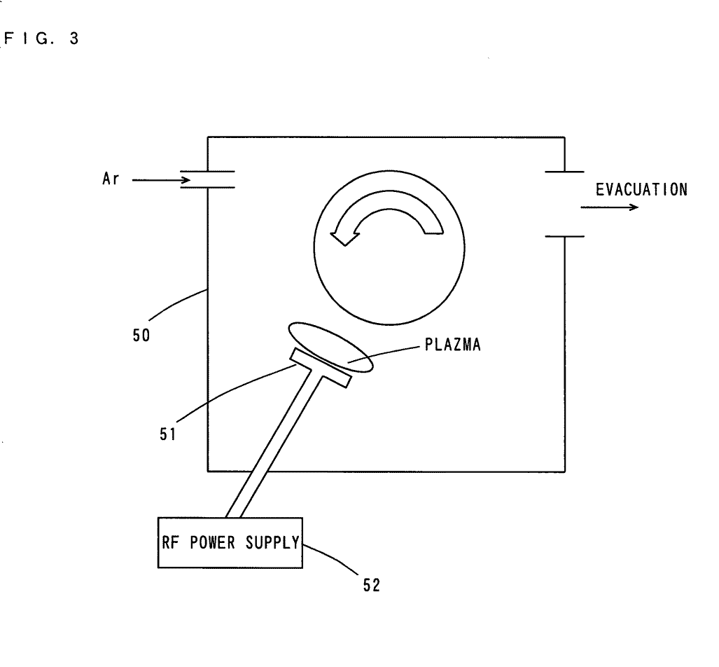

A negative electrode active material layer of elemental germanium (Ge) as thick as 0.5 μm for example is deposited on the negative electrode collector of the rolled foil described above using a sputtering machine shown in FIG. 3 and germanium powder. The deposition condition is given in Table 1. Note that the deposited elemental germanium is amorphous. The elemental germanium to be deposited may be in a thin film state or a foil state.

TABLE 1

| | | | |
|---|---|---|---|
| sputter source | RF frequency | 13.56 | MHz |
| | RF power | 200 | W |

| argon flow rate | 50 | sccm |
|---|---|---|
| gas pressure | 1.7 to 1.8 × 10⁻¹ Pa | |
| time | 30 | min |
| thickness | 0.5 | μm |

To begin with, a chamber 50 is evacuated to 1×10⁻⁴ Pa, then argon is introduced in the chamber 50 and the gas pressure in the chamber 50 is stabilized in the range from 1.7 to 1.8×10⁻¹ Pa.

Then, while the gas pressure in the chamber 50 is thus stabilized, a sputter source 51 of germanium is provided with radio frequency power by a radio frequency power supply 52 for a prescribed period. In this way, a negative electrode active material layer of the germanium is deposited on the negative electrode collector.

Then, the negative electrode collector having the negative electrode active material layer of the elemental germanium deposited thereon is cut into a 2-by-2-cm piece and a negative electrode tab is attached to the piece to produce the working electrode 1.

The arithmetic mean roughness Ra as defined by Japanese Industrial Standards (JIS B 0601-1994) in the surface-roughened rolled foil described above is preferably not less than 0.1 μm nor more than 10 μm.

<Effects of Embodiment>

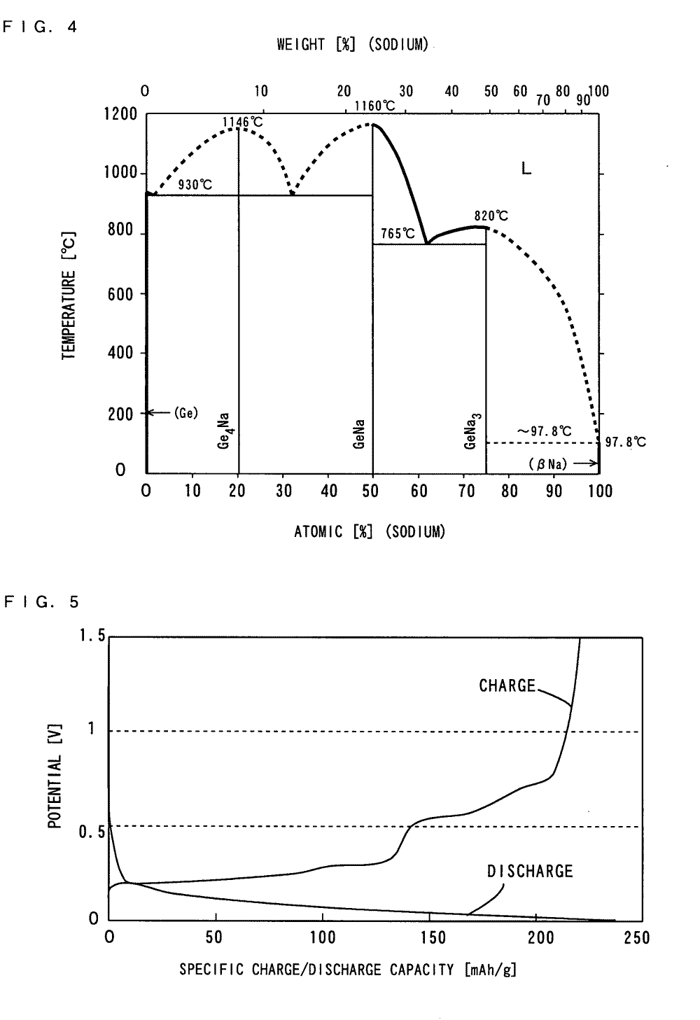

As can be understood from the binary phase diagram of elemental germanium and sodium in FIG. 4, the elemental germanium and the sodium are alloyed. However, there had not been findings about whether the elemental germanium was capable of storing and releasing sodium ions before the present application.

According to the embodiment, using the negative electrode containing the elemental germanium, sodium ions are sufficiently stored in and released from the negative electrode. In addition, the use of sodium that is available in abundance as a resource can reduce the cost.

According to the embodiment, the use of the negative electrode described above allows reversible charge and discharge to be carried out and an inexpensive non-aqueous electrolyte secondary battery to be provided.

### Third Embodiment

A non-aqueous electrolyte secondary battery according to the embodiment is different from the non-aqueous electrolyte secondary battery according to the first embodiment in the structures of the negative electrode and the positive electrode, which will be described in detail.

<Manufacture of Working Electrode>

A rolled foil of surface roughened copper as thick as 26 μm for example having a surface formed into an irregular shape with copper precipitated thereon by an electrolytic method is prepared as a negative electrode collector.

A negative electrode active material layer of elemental germanium as thick as 0.5 μm for example is deposited on the negative electrode collector of the rolled foil described above using the above-described sputtering machine shown in FIG. 3 and germanium powder. The deposition condition is the same as that in Table 1. Note that the deposited elemental germanium is amorphous. The elemental germanium to be deposited may be in a thin film state or a foil state.

To begin with, the chamber 50 is evacuated to 1×10⁻⁴ Pa, then argon is introduced in the chamber 50 and the gas pressure in the chamber 50 is stabilized in the range from 1.7 to 1.8×10⁻¹ Pa.

Then, while the gas pressure in the chamber 50 is thus stabilized, a sputter source 51 of germanium is provided with radio frequency power by a radio frequency power supply 52 for a prescribed period. In this way, a negative electrode active material layer of the germanium is deposited on the negative electrode collector.

Then, the negative electrode collector having the negative electrode active material layer of the elemental germanium deposited thereon is cut into a 2-by-2 cm piece and a negative electrode tab is attached to the piece to produce a working electrode 1.

<Manufacture of Counter Electrode>

A material containing for example 85 parts by weight of sodium manganate (NaₓMnO_{2+y}) (for example 0<x≦1, −0.1<y<0.1) powder as a positive electrode active material, and 10 parts by weight of Ketjenblack, carbon black powder serving as a conductive agent are mixed into a 10 wt % N-methyl-pyrrolidone solution containing 5 parts by weight of polyvinylidene fluoride as a binder and slurry as a positive electrode mixture is produced. Note that the sodium manganate contained in the positive electrode active material is for example Na_{0.7}MnO_{2+y} where x in the above formula is substituted by 0.7.

Then, the slurry is for example applied by a doctor blade method on a 3-by-3 cm region of an aluminum foil as thick as 18 μm for example as a positive electrode collector, then dried and formed into a positive electrode active material layer.

Then, a positive electrode tab is attached on a region of the aluminum foil where the positive electrode active material layer is not formed to form a positive electrode.

<Effect of Embodiment>

According to the embodiment, the use of negative electrode containing the elemental germanium allows sodium ions to be sufficiently stored in and released from the negative electrode. In this way, a good charge/discharge cycle can be obtained. The use of sodium that is available in abundance as a resource can reduce the cost.

The use of the negative electrode allows reversible charge and discharge to be carried out and an inexpensive non-aqueous electrolyte secondary battery to be provided.

### INVENTIVE EXAMPLES

### Inventive Example 1 and Evaluation Thereof

As in the following paragraphs, a test cell produced according to the first embodiment was used to examine the charge/discharge characteristic of the non-aqueous electrolyte secondary battery.

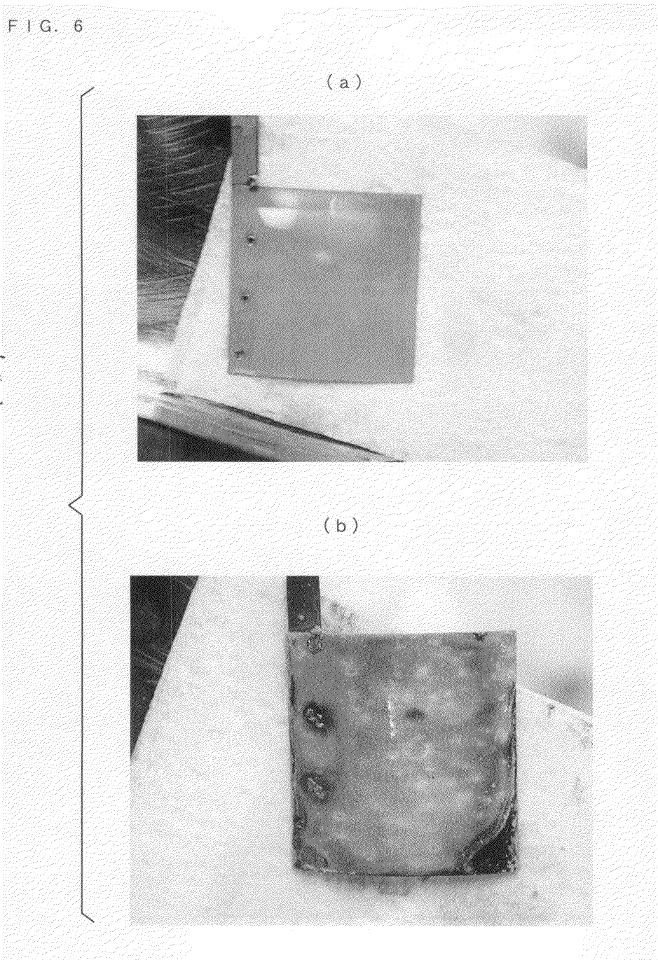

FIG. 5 is a graph showing the charge/discharge characteristic of a non-aqueous electrolyte secondary battery according to Inventive Example 1.

In the produced test cell, discharge was carried out until the potential of the working electrode 1 with respect to the reference electrode 3 reached 0 V with a constant current of 0.72 mA.

Then, with a constant current of 0.72 mA, charge was carried out until the potential of the working electrode 1 with respect to the reference electrode 3 reached 1.5 V and the charge/discharge characteristic was examined.

It was found as a result that the specific discharge capacity per gram of the active material of the working electrode 1 was about 221 mAh/g and good charge and discharge was performed.

More specifically, it was found that sodium ions were reversibly stored in and released from the working electrode 1. In this way, the advantage of the new non-aqueous electrolyte secondary battery over the conventional non-aqueous electrolyte secondary battery using lithium ions was recognized.

Then, the test cell was disassembled and the working electrode 1 while sodium ions were stored therein was observed.

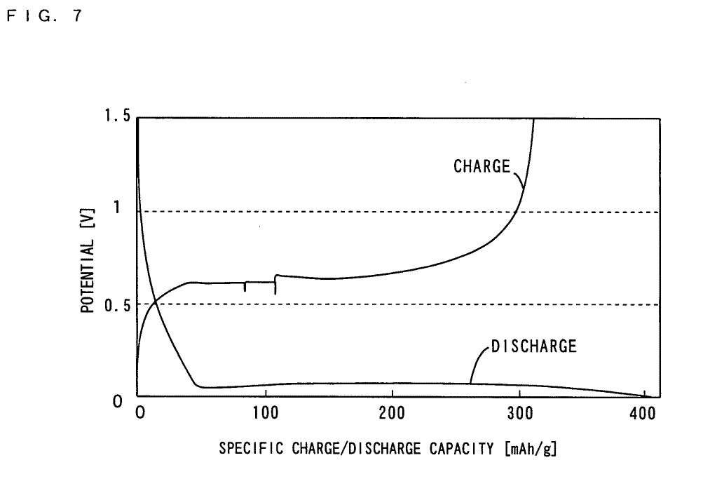

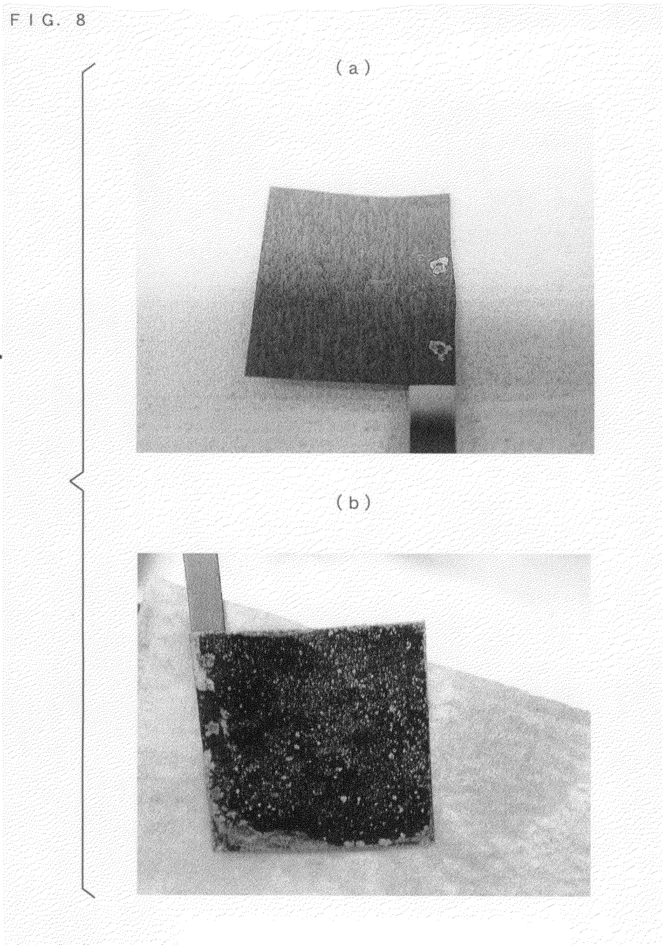

FIG. 6(a) is a photograph of the working electrode 1 before sodium ions were stored therein, and FIG. 6(b) is a photograph of the working electrode 1 after sodium ions were stored therein. The color of the working electrode 1 changed from purple gray before the storage to gray after the storage as the electrode stored sodium ions.

### Inventive Example 2 and Evaluation Thereof

As in the following paragraphs, a test cell produced according to the second embodiment was used to examine the charge/discharge characteristic of the non-aqueous electrolyte secondary battery.

FIG. 6 is a graph showing the charge/discharge characteristic of a non-aqueous electrolyte secondary battery according to Inventive Example 2.

In the produced test cell, discharge was carried out until the potential of the working electrode 1 with respect to the reference electrode 3 reached 0 V with a constant current of 0.1 mA.

Then, with a constant current of 0.1 mA, charge was carried out until the potential of the working electrode 1 with respect to the reference electrode 3 reached 1.5 V and the charge/discharge characteristic was examined.

It was found as a result that the specific discharge capacity per gram of the active material of the working electrode 1 was about 312 mAh/g and good charge and discharge was performed.

More specifically, it was found that sodium ions were reversibly stored in and released from the working electrode 1. In this way, the advantage of the new non-aqueous electrolyte secondary battery over the conventional non-aqueous electrolyte secondary battery using lithium ions was recognized.

Then, the test cell was disassembled and the working electrode 1 was observed while the electrode stored sodium ions.

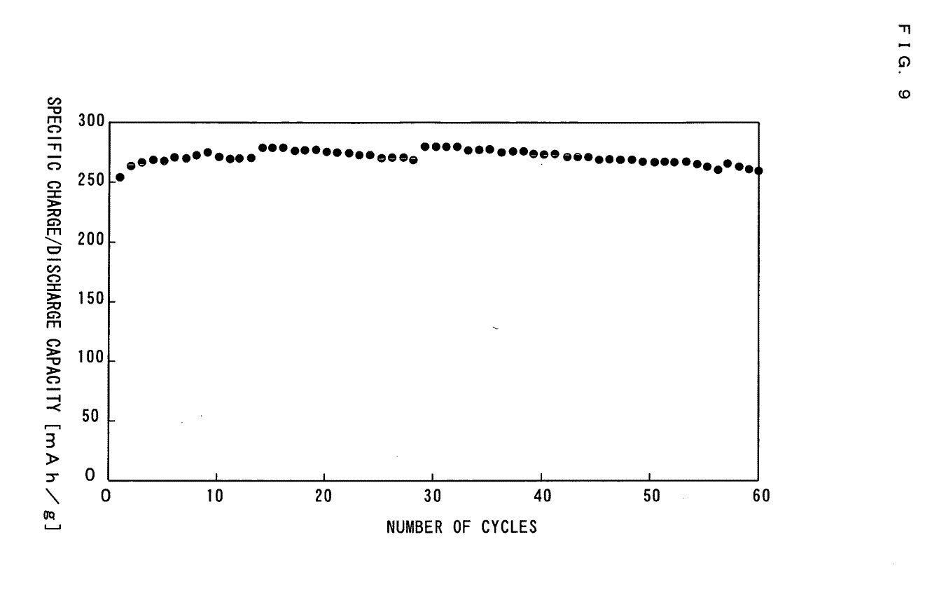

FIG. 8(a) is a photograph of the working electrode 1 before sodium ions were stored therein, and FIG. 8(b) is a photograph of the working electrode 1 after sodium ions were stored therein. The color of the working electrode 1 changed from brown before the storage to black after the storage as the electrode stored sodium ions.

### Inventive Example 3 and Evaluation Thereof

A test cell produced according to the third embodiment was used to examine the charge/discharge characteristic of the non-aqueous electrolyte secondary battery. Note that the capacity of the working electrode 1 was 4 mAh, the capacity of the counter electrode 2 was 50 mAh and the following charge/discharge cycle test was performed so that the amount of sodium in the counter electrode 2 was excessive.

FIG. 9 is a graph showing the charge/discharge characteristic of a non-aqueous electrolyte secondary battery according to Inventive Example 3.

In the produced test cell, discharge was carried out until the potential of the working electrode 1 reached 0 V with respect to the reference electrode 3 with a constant current of 1 mA.

Then, charge was carried out until the potential of the working electrode 1 with respect to the reference electrode 3 reached 1.5 V with a constant current of 1 mA and the charge/discharge cycle characteristic was examined.

As a result, as shown in FIG. 9, the specific discharge capacity per gram of the negative electrode active material was initially about 255 mAh/g, while the specific discharge capacity per gram of the negative electrode active material was about 257 mAh/g after 60 cycles and a good charge/discharge cycle characteristic was obtained.

### INDUSTRIAL APPLICABILITY

The non-aqueous electrolyte secondary battery according to the invention may be applied as various kinds of power supplies such as a portable power supply and an automotive power supply.

1. A non-aqueous electrolyte secondary battery, comprising a negative electrode, a positive electrode, and a non-aqueous electrolyte including sodium ions, said negative electrode including elemental tin or elemental germanium.

2. The non-aqueous electrolyte secondary battery according to claim 1, wherein said negative electrode further includes a collector including a metal, and
said elemental tin and elemental germanium are formed into a thin film state on said collector.

3. The non-aqueous electrolyte secondary battery according to claim 2, wherein said collector has a roughened surface.

4. The non-aqueous electrolyte secondary battery according to claim 2, wherein the arithmetic mean roughness of the surface of said collector is not less than 0.1 μm nor more than 10 μm.

5. The non-aqueous electrolyte secondary battery according to claim 1, wherein said non-aqueous electrolyte includes sodium hexafluorophosphate.

6. The non-aqueous electrolyte secondary battery according to claim 1, wherein said non-aqueous electrolyte includes one or more selected from the group consisting of a cyclic carbonate, a chain carbonate, esters, cyclic ethers, chain ethers, nitrites, and amides.

7. (canceled)
